(19) United States
(12) Patent Application Publication
(10) Pub. No.: US 2017/0093032 A1
(43) Pub. Date: Mar. 30, 2017

(54) Radio-Frequency Apparatus With Integrated Antenna Control and Associated Methods

(71) Applicant: Silicon Laboratories Inc., Austin, TX (US)

(72) Inventors: John M. Khoury, Austin, TX (US); Mustafa Koroglu, Austin, TX (US); Abdulkerim Coban, Austin, TX (US); Ramin Khoini-Poorfard, Austin, TX (US)

(21) Appl. No.: 14/869,916

(22) Filed: Sep. 29, 2015

(51) Int. Cl. H01Q 1/50; H04B 7/02

(52) U.S. Cl. CPC H01Q 1/50; H04B 7/02

(57) ABSTRACT

An apparatus includes an integrated circuit (IC), which includes a radio-frequency (RF) circuit to process RF signals, and a balun that has first and second ports. First and second switches are coupled to the second port of the balun. The first port of the balun is coupled to the RF circuit.

### TECHNICAL FIELD

The disclosure relates generally to radio-frequency (RF) apparatus and methods. More particularly, the disclosure relates to RF apparatus with integrated antenna control, and associated methods.

### BACKGROUND

With the increasing proliferation of wireless technology, such as Wi-Fi, Bluetooth, and mobile or wireless Internet of things (IoT) devices, more devices or systems incorporate RF circuitry, such as receivers and/or transmitters. To reduce the cost, size, and bill of materials, and to increase the reliability of such devices or systems, various circuits or functions have been integrated into integrated circuits (ICs). For example, ICs typically include receiver and/or transmitter circuitry.

In a radio receiver (or transmitter), having two receive (or transmit) antennae can improve reception (or transmission). In one form, a “diversity” receiver can selects one antenna from a group of antennae, for example, two antennae, based on some pre-determined criterion. In typical implementations of antenna diversity, an off-chip (not integrated) antenna switch and/or front-end module (FEM) is controlled by the radio IC.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes an IC. The IC includes a radio-frequency (RF) circuit to process RF signals, and a balun that has first and second ports. First and second switches are coupled to the second port of the balun. The first port of the balun is coupled to the RF circuit.

According to another exemplary embodiment, an apparatus includes first and second antennae and an IC. The IC includes an RF circuit to process RF signals, and a balun coupled to the RF circuit. The IC further includes first and second integrated switches coupled to the balun. The first and second integrated switches are further coupled to the first and second antennae to allow selecting one of the first and second antennae.

According to another exemplary embodiment, a method of using first and second antennae in an RF apparatus is disclosed. The RF apparatus includes an IC that has integrated in it (a) RF circuitry to process RF signals, (b) a balun having first and second nodes, and (c) first and second switches coupled to the first and second nodes of the balun. The method includes controlling the first switch to couple to ground the first node of the balun in order for the RF circuitry to use the second antenna. The method includes controlling the second switch to couple to ground the second node of the balun in order for the RF circuitry to use the first antenna.

### BRIEF DESCRIPTION OF THE DRAWINGS

The appended drawings illustrate only exemplary embodiments and therefore should not be considered as limiting the scope of the application or the claims. Persons of ordinary skill in the art appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement for an apparatus according to a first exemplary embodiment.

FIG. 2 depicts a circuit arrangement for an apparatus according to a second exemplary embodiment.

FIG. 3 shows a circuit arrangement for an apparatus according to a third exemplary embodiment.

FIG. 4 depicts a circuit arrangement for an apparatus according to a fourth exemplary embodiment.

FIG. 5 illustrates a circuit arrangement for an apparatus according to a fifth exemplary embodiment.

FIG. 6 depicts a circuit arrangement for an apparatus according to a sixth exemplary embodiment.

FIG. 7 illustrates a first switch for use in apparatus according to exemplary embodiments.

FIG. 8 shows a second switch for use in apparatus according to exemplary embodiments.

FIG. 9 depicts a circuit arrangement for a switch for use in apparatus according to exemplary embodiments.

FIG. 10 illustrates another circuit arrangement for a switch for use in apparatus according to exemplary embodiments.

### DETAILED DESCRIPTION

The disclosed concepts relate generally to RF apparatus. More specifically, the disclosed concepts relate to RF apparatus with integrated antenna control, and associated methods. In exemplary embodiments, an IC includes within it integrated control circuitry, antenna interface circuitry, and/or switches that interface with two or more antennae in an antenna diversity scheme.

In a radio receiver (and/or transmitter), having two receive (and/or transmit) antennae can improve reception (and/or transmission). In typical implementations of antenna diversity, an off-chip antenna switch and/or front-end module (FEM) is controlled by a controller. The controller may reside in the same IC as does the RF circuitry. For example, one (or more) general-purpose input/output (GPIO) on the IC may be used to control the antenna diversity switch(es) from the radio IC.

Antenna diversity implementations according to exemplary embodiments eliminate the external FEM or switches. More specifically, in exemplary embodiments, the antenna selection switching and related control are integrated within the same IC that includes the RF circuitry (receive and/or transmit circuitry).

Various embodiments according to the disclosure provide a number of advantages over conventional approaches. For example, integrating the control circuitry, antenna interface circuitry, and/or switches within the IC eliminates the use of off-chip circuitry or components. Furthermore, elimination of the off-chip circuitry or components results in saving one or more package pins of the IC (that would ordinarily be used to control off-chip circuitry/components). In addition, reducing the number and size of the components as a result of the increased integration reduces the overall size, cost, and bill-of-materials for the circuit, block, sub-system, or system in which the RF circuit or device resides.

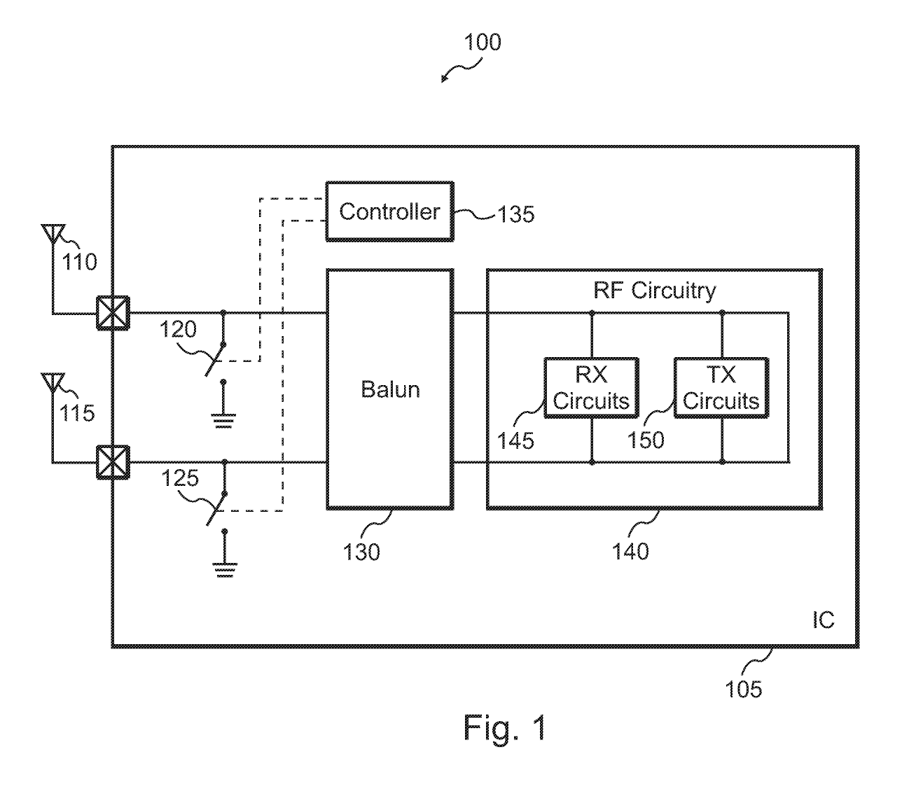

FIG. 1 illustrates a circuit arrangement 100 for antenna control according to an exemplary embodiment. Circuit arrangement 100 includes IC 105, antenna 110, and antenna 115. IC 105 includes switch 120, switch 125, balun 130, controller 135, and RF circuitry 140. RF circuitry 140 includes receive circuits (labeled “RX circuits”) 145 and/or transmit circuits (labeled “TX circuits”) 150.

Note that FIG. 1 shows a block diagram of circuit arrangement 100, and that other blocks of circuitry may be included, as desired. For example, in some embodiments, apparatus 100 may include power supply or conversion circuits, control circuits, and the like, as persons of ordinary skill in the art will understand.

As noted, in some embodiments, receive circuits 145 are used in order to receive and process RF signals via one of antennae 110 and 115. When used in exemplary embodiments, receive circuits 145 may include a variety of circuits, such as downconverters, analog-to-digital converters (ADCs), digital-to-analog converters (DACs), decoders, demodulators, error-correction circuitry, amplifiers (including low-noise amplifiers (LNAs), signal sources (such as frequency synthesizers), and the like, as persons of ordinary skill in the art will understand. The choice of circuits included or used in receive circuits 145 depends on factors such as design and performance specifications, intended use, cost and performance goals, etc., as persons of ordinary skill in the art will understand.

As noted, in some embodiments, transmit circuits 150 is used in order to process and transmit RF signals via one of antennae 110 and 115. When used in exemplary embodiments, transmit circuits 150 may include a variety of circuits, such as upconverters, analog-to-digital converters (ADCs), digital-to-analog converters (DACs), encoders, modulators, amplifiers (including power amplifiers (PAs), signal sources (such as frequency synthesizers), and the like, as persons of ordinary skill in the art will understand. The choice of circuits included or used in transmit circuits 150 depends on factors such as design and performance specifications, intended use, cost and performance goals, etc., as persons of ordinary skill in the art will understand.

Receive circuits 145 and/or transmit circuits 150 are coupled to antenna 110 and antenna 115 via balun 130. Specifically, receive circuits 145 and/or transmit circuits 150 are coupled to one port of balun 130. A second port of balun 130 couples to antenna 110 and antenna 115. The second port of balun 130 also couples to switch 120 and to switch 125.

More specifically, one node of the second port of balun 130 couples to antenna 110 and to switch 120. Switch 120, when closed, blocks antenna 110 or, stated another way, shorts to ground the signal to/from antenna 110. When open, however, switch 120 allows the signal to/from antenna 110 to couple to receive circuits 145 and/or transmit circuits 150. Thus, if receive circuits 145 are used, the signal from antenna 110 is provided to receive circuits 145 via balun 130. If transmit circuits 150 are used, the signal from transmit circuits 150 is provided to antenna 110 via balun 130.

Similarly, another node of the second port of balun 130 couples to antenna 115 and to switch 125. When closed, switch 125 blocks antenna 115. Put another way, when closed, switch 125 shorts to ground the signal to/from antenna 115. On the other hand, when open, switch 125 allows the signal to/from antenna 115 to couple to receive circuits 145 and/or transmit circuits 150. If receive circuits 145 are used, the signal from antenna 115 is provided to receive circuits 145 via balun 130. If transmit circuits 150 are used, the signal from transmit circuits 150 is provided to antenna 115 via balun 130.

A controller 135 controls the operation of switch 120 and switch 125. More specifically, controller 135 opens and closes switch 120 and switch 125 in order to select antenna 110 or antenna 115 to receive or transmit RF signals (i.e., by using receive circuits 145 or transmit circuits 150, respectively, in RF circuitry 140).

For example, suppose that one seeks to receive RF signals via antenna 110. Controller 135 causes switch 120 to open, and switch 125 to close. As noted, when closed, switch 125 blocks antenna 115, i.e., shorts to ground the signal from antenna 115. As a result, the RF signal from antenna 110 is provided to RF circuitry 140 (more specifically to receive circuits 145) via balun 130.

As another example, a similar scenario may be used to transmit RF signals from antenna 110. In this situation, controller 135 causes switch 120 to open, and switch 125 to close. When closed, switch 125 blocks antenna 115, i.e., shorts to ground the signal that would otherwise reach antenna 115. As a result, the RF signal from RF circuitry 140 (more specifically from transmit circuits 150) is provided to antenna 110 via balun 130.

Conversely, controller 135 may control switch 110 and switch 115 in a similar manner in order to use antenna 115, rather than antenna 110. For instance, suppose that one seeks to receive RF signals via antenna 115. To accomplish that goal, controller 135 causes switch 125 to open, and switch 120 to close. As noted, when closed, switch 120 blocks antenna 110, i.e., shorts to ground the signal from antenna 110. Consequently, the RF signal from antenna 115 is provided to RF circuitry 140 (more specifically to receive circuits 145) via balun 130.

As another example, suppose that one seeks to transmit RF signals from antenna 115. To do so, controller 135 causes switch 125 to open, and switch 120 to close. By virtue of switch 120 being closed, it blocks antenna 110, i.e., shorts to ground the signal that would otherwise reach antenna 110. As a result, the RF signal from RF circuitry 140 (more specifically from transmit circuits 150) is provided to antenna 115 via balun 130.

Thus, using switch 120 and switch 125 allows shorting to ground an antenna path corresponding to an unselected antenna, as described above. Doing so allows the antenna path corresponding to the selected antenna to be enabled and for the selected antenna to be available for reception or transmission, as desired. Furthermore, note that the active or selected antenna path does not pass through any switches, which provides higher linearity and lower noise compared to the case where switches (e.g., external to IC 105) are used to connect or disconnect the antennae from IC 105.

Generally speaking, a variety of balun configurations may be used, as desired. The choice of the type and configuration of the balun depends on a variety of factors, as persons of ordinary skill in the art will understand. Such factors include performance and design considerations for IC 105, cost, IC die area, available fabrication technology, ease of design, manufacturing, and/or testing, etc.

Note that the first port of balun 130 couples to RF circuitry 150 in a balanced configuration. Conversely, the second port of balun 130 couples to antenna 110 or antenna 115 in an unbalanced configuration. More specifically, to select one of antenna 110 and antenna 115 to receive RF signals or to transmit RF signals, one of switches 120 and 125 is opened, and the other of switches 120 and 125 is closed. As a result, the second port of balun 130 is coupled to the selected antenna in an unbalanced configuration.

In some embodiments, balun 130 includes a transformer. In such a scenario, receive circuits 145 and/or transmit circuits 150 are coupled to one winding or side of the transformer, say, the primary or primary winding. Similarly, antenna 110, antenna 115, switch 120, and switch 125 are coupled to the other winding or side of the transformer, in this example, the secondary or secondary winding. In effect, in the example described, the balun constitutes a two-port network, with the primary and secondary sides or windings of the transformer corresponding to the first and second ports of the two-port network, respectively.

Note that, in some embodiments, rather than using a transformer-based balun 130 as shown in FIG. 1, multiple matching networks, such as inductor-capacitor (LC) networks, may be integrated in IC 105 and used. The matching networks would in such embodiments couple RF circuitry 140 to antenna 110 and antenna 115. By activating receive circuits 145 or transmit circuits 150, RF circuitry may receive or transmit RF signals via the matching networks, respectively.

As noted above, by using controller 135, antenna 110 or antenna 115 may be used for RF signal reception or transmission as part of an antenna diversity scheme. In exemplary embodiments, the selection of antenna 110 or antenna 115 by controller 135 may be performed in variety of ways.

For instance, in some embodiments, during power-up or configuration of IC 105, controller 135 may be instructed or programmed or configured to use antenna 110 or antenna 115. As another example, alternatively or in addition, controller 135 may be instructed or programmed or configured to use antenna 110 or antenna 115 during use of IC 105, for example, in response to instructions by a user of IC 105 or another block or circuit or subsystem in a system or apparatus that uses or includes IC 105.

As another example, controller 135 may select antenna 110 or antenna 115 dynamically during operation of IC 105, based on one or more criteria. The selected antenna may be used to receive RF signals, to transmit RF signals, or both, as desired.

An example of antenna selection criteria may include signal strength. More specifically, receiver circuits 145 may receive an RF signal using antenna 110 and also using antenna 115. The strength (level, power, received signal strength indication (RSSI), etc.) of the received RF signal when using antenna 110 may be compared to the strength of the received RF signal when using antenna 115. The antenna corresponding to the stronger received RF signal may then be selected and used for further RF signal reception.

In some embodiments, the selected antenna may also be used for RF signal transmission, as desired. In other embodiments, one or more different or additional criteria may be used to select an antenna for RF signal transmission, as desired.

For example, an antenna may be selected, and an RF signal transmitted using that antenna. An assessment of the strength of a received signal corresponding to the transmitted signal may be made (e.g., by a remote receiver). This operation may be repeated by selecting and using the other antenna. Depending on which of the received signals corresponding to antenna 110 and antenna 115 is stronger, antenna 110 or antenna 115 may be used for additional RF signal transmission.

Note that FIG. 1 shows a generalized block diagram of an apparatus that includes both RF signal reception and RF signal transmission capability. A variety of alternatives are possible and contemplated. For example, in some embodiments, RF signal reception capability, but not RF signal transmission capability, may be desired. In such embodiments, transmit circuits 150 may be omitted, and receive circuits 145 may be used for RF signal reception.

As another example, in some embodiments, RF signal transmission capability, but not RF signal reception capability, may be desired. In such embodiments, receive circuits 145 may be omitted, and transmit circuits 150 may be used for RF signal transmission.

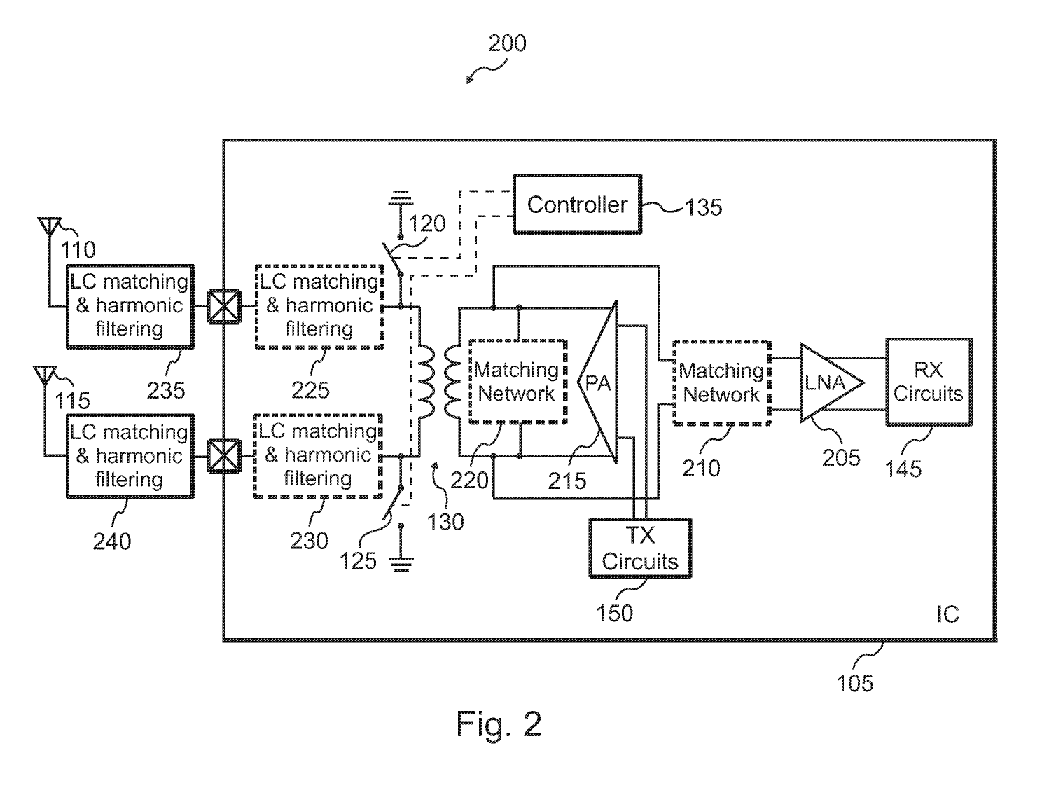

Whether IC 105 includes RF reception capability, RF transmission capability, or both, the antenna control circuitry that includes switch 120 and switch 125 may be used advantageously, as described. Similar considerations and comments apply to the circuit arrangements in FIGS. 2-6.

Another aspect of the disclosure relates to using matching networks, sometimes called impedance matching networks, with antenna control circuitry. The matching networks provide a mechanism for coupling together circuitry or blocks of circuitry that might otherwise have impedance mismatches.

For example, an antenna might present a given characteristic impedance, say, Zₐₙₜ, whereas RF circuitry 140 (whether receive circuits 145 or transmit circuits 150, or both) might have a characteristic impedance Z_{RF}, with a complex conjugate Z_{RF*}. As persons of ordinary skill in the art understand, to achieve maximum power transfer to/from such an antenna to/from RF circuitry (at radio frequencies, designers often seek to reduce power loss and maximize power transfer), the following relationship should hold:

Zₐₙₜ=Z_{RF*}

If, by virtue of their design or characteristics, the antenna and RF circuitry 140 have difference characteristic impedances, i.e., Zₐₙₜ≠Z_{RF*}, one or more matching networks may be used in order to match Zₐₙₜ to Z_{RF*}. The matching networks typically are coupled between the devices or circuits (or to the devices or circuits) that have differing impedances, such as the antenna and RF circuitry 140, in the above example.

FIG. 2 illustrates a circuit arrangement 200 for antenna control according to an exemplary embodiment. Circuit arrangement 200 operates in a similar manner to circuit arrangement 100 (see FIG. 1), except for the addition of several matching networks (and explicitly illustrating PA 215 and LNA 205).

More specifically, referring to FIG. 2, circuit arrangement 200 includes LC matching and harmonic filtering networks 225 and 235. LC matching and harmonic filtering networks 225 and 235 are coupled between antenna 110 and balun 130. LC matching and harmonic filtering networks 225 and 235 provide impedance matching between antenna 110 and balun 130. In addition, LC matching and harmonic filtering networks 225 and 235 may provide filtering of harmonic signals (or other spurious or undesired signals) in the signal path between antenna 110 and balun 130.

Similarly, LC matching and harmonic filtering networks 230 and 240 are coupled between antenna 115 and balun 130. LC matching and harmonic filtering networks 230 and 240 provide impedance matching between antenna 115 and balun 130. In addition, LC matching and harmonic filtering networks 230 and 240 may provide filtering of harmonic signals (or other spurious or undesired signals) in the signal path between antenna 115 and balun 130.

Circuit arrangement 200 further includes matching network 220. Matching network 220 couples to PA 215 and balun 130, and provides impedance matching between them. Transmit circuits 150 drive PA 215 during the transmit mode of the apparatus in FIG. 2.

In addition, circuit arrangement 200 includes matching network 210. Matching network 210 is coupled between balun 130 and LNA 205, and provides impedance matching between them. LNA 205 amplifies the RF signal received from balun 130, and provides the amplified RF signal to receive circuits 145 during the receive mode of the apparatus in FIG. 2.

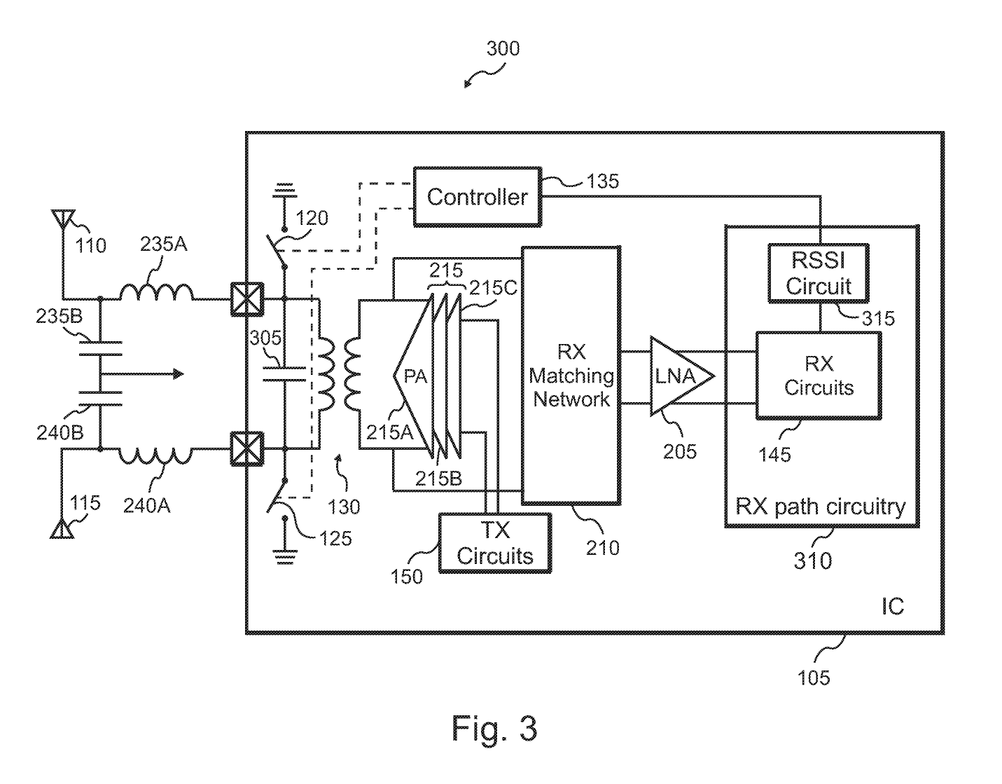

FIG. 3 illustrates a circuit arrangement 300 for antenna control according to an exemplary embodiment. Circuit arrangement 300 is similar to circuit arrangement 200 in FIG. 2, and operates in a similar manner. Referring to FIG. 3, circuit arrangement 300 shows examples of some of the matching networks used to provide impedance matching between various circuit elements or blocks in the apparatus that includes IC 105.

More specifically, in the embodiment shown in FIG. 3, LC matching and harmonic filter 235 includes inductor 235A and capacitor 235B. Similarly, LC matching and harmonic filter 240 includes inductor 240A and capacitor 240B.

Capacitor 305 is used as another part of the matching network. Capacitor 305 is coupled across the second port of balun 130. Together with LC matching and harmonic filter 235 and LC matching and harmonic filter 240, capacitor 305 provides impedance matching between antennae 110 and 115 and balun 130.

Note that PA 215 in FIG. 3 includes several PA slices or PA circuits 215A-215C. PA slices 215A-215C may include circuitry for individual PAs. Depending on factors such as desired transmit power (or range), frequency or band of operation, and the like, one or more of PA slices 215A-215C may be activated and used to drive a selected one of antennae 110-115.

Circuit arrangement 300 shows three PA slices 215A, 215B, and 215C. As persons of ordinary skill in the art will understand, however, other numbers of PA slices may be used, depending on factors such as desired power levels, design and performance specifications, available technology, etc.

Circuit arrangement 300 shows receive path circuitry (labeled as “RX path circuitry”) 310, which includes receive circuits 145 and RSSI circuit 315. RSSI circuit 315 determines a signal strength of the RF signal received by receive circuits 145 via a selected one of antennae 110-115. RSSI circuit 315 provides an indication of the received signal strength to controller 135. Controller 135 may use the information or indication of the received signal strength as a criterion in selecting one of antennae 110-115 by using switches 120-125, as described above in detail.

As noted above, RF circuitry 140 in FIG. 1 (and receive circuits 145 and TX circuits 150 in FIG. 2) operate in a balanced manner. Balun 130 provides an interface between RF circuitry 140 (or receive circuits 145 and TX circuits 150) and unbalanced (or single-ended) circuitry such as antenna 110 and antenna 115.

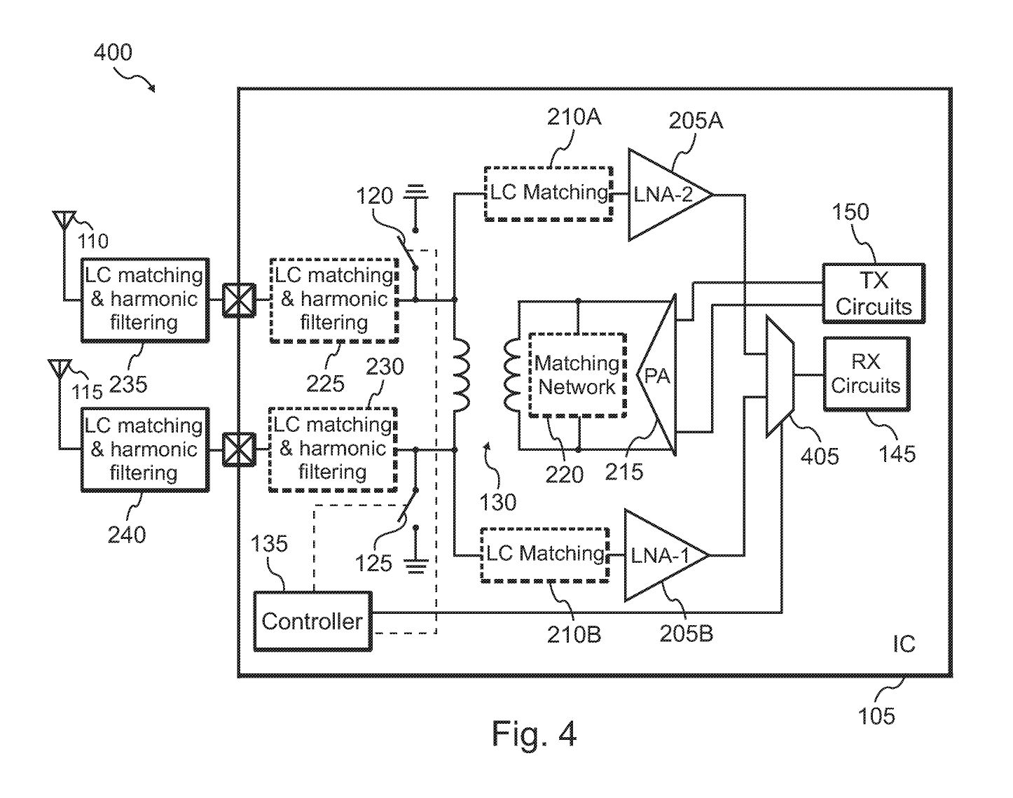

One aspect of the disclosure relates to providing integrated antenna control where one or more blocks of circuitry in RF circuits 140 does not operate in a balanced manner. FIG. 4 illustrates a circuit arrangement 400 for antenna control according to an exemplary embodiment, where LNA circuits 205A and 205B do not operate in a balanced manner, i.e., do not use the balanced-unbalanced interface functionality of balun 130.

More specifically, the receive path of the apparatus shown in FIG. 4 does not use the balanced-unbalanced interface functionality of balun 130. To accommodate this scenario, two LNAs, 205A-205B, are used, rather than LNA 205 in FIG. 2. Referring again to FIG. 4, two LC matching networks 210A-210B are used (rather than matching network 210 in FIG. 2).

LNAs 205A and 205B may be powered selectively, depending on which of antennae 110-115 is used. More specifically, when antenna 110 is selected and used (by closing switch 125 and opening switch 120), LNA 205A may be powered to receive and amplify the RF signal that antenna 110 provides. LNA 205B may be powered down (e.g., by using biasing circuitry or a switch (not shown)) as desired to reduce the power consumption of IC 105.

Conversely, when antenna 115 is selected and used (by closing switch 120 and opening switch 125), LNA 205B may be powered to receive and amplify the RF signal from antenna 115. LNA 205A, however, may be powered down (e.g., by using biasing circuitry or a switch (not shown)) as desired to reduce the power consumption of IC 105.

Furthermore, circuit arrangement 400 uses a multiplexer (MUX) 405 to route the output signals of LNAs 205A-205B to receive circuits 145. More specifically, in response to a control signal from controller 135, MUX 405 routes selectively either the output signal of LNA 205A or the output signal of LNA 205B to receive circuits 145. Receive circuits 145 processes the received RF signal (from LNA 205A or LNA 205B), as discussed above.

Although circuit arrangement 400 illustrates the situation where the receive path of the apparatus in FIG. 4 does not use the balanced-unbalanced interface functionality of balun 130, other arrangements are possible, as persons of ordinary skill in the art will understand. For example, in some embodiments, the transmit path of IC 105 may not use the balanced-unbalanced interface functionality of balun 130. In this situation, two PAs (rather than PA 215) and, if desired, two matching networks (rather than matching network 220) may be used. Furthermore, a switching or routing mechanism, similar to MUX 405, may be used to route the transmit signal from transmit circuits 150 to the respective inputs of the two PAs.

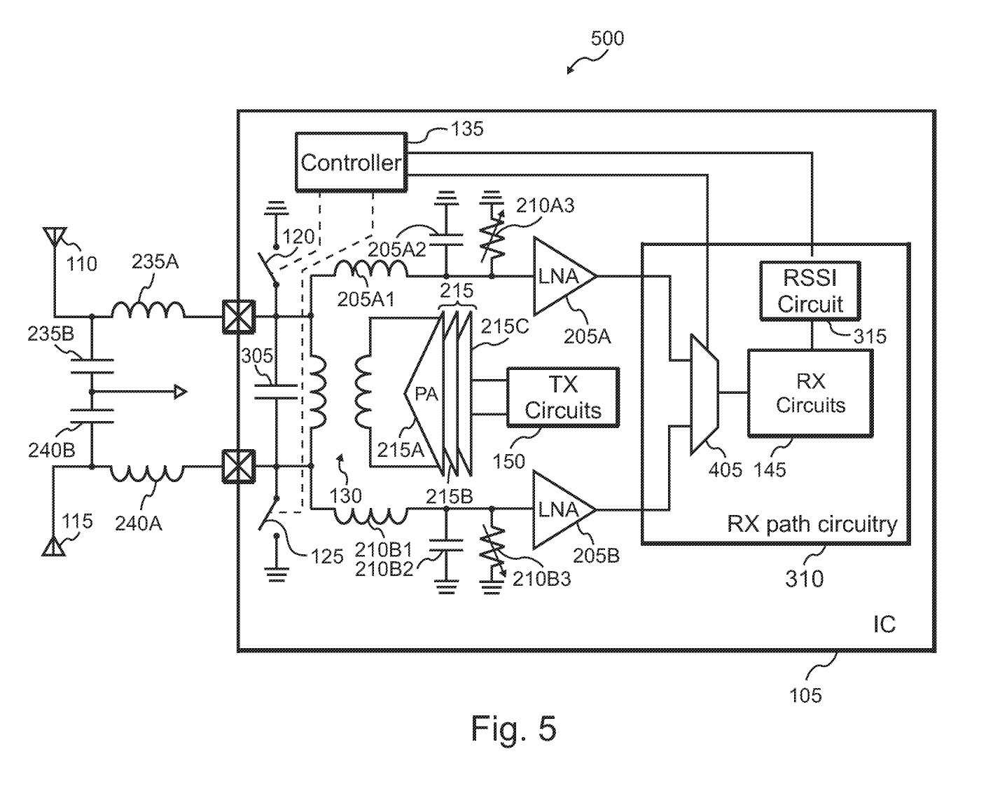

FIG. 5 illustrates a circuit arrangement 500 for antenna control according to an exemplary embodiment. Circuit arrangement 500 is similar to circuit arrangement 400 in FIG. 4, and operates in a similar manner. Referring to FIG. 5, circuit arrangement 500 shows examples of some of the matching networks used to provide impedance matching between various circuit elements or blocks in the apparatus that includes IC 105.

More specifically, in the embodiment shown in FIG. 5, LC matching and harmonic filter 235 includes inductor 235A and capacitor 235B. Similarly, LC matching and harmonic filter 240 includes inductor 240A and capacitor 240B.

Capacitor 305 is used as another matching network. Capacitor 305 is coupled across the second port of balun 130. Together with LC matching and harmonic filter 235 and LC matching and harmonic filter 240, capacitor 305 provides impedance matching between antennae 110-115 and balun 130.

Furthermore, LC matching network 210A (see FIG. 4) is implemented in circuit arrangement 500 as inductor 205A1 and capacitor 205A2. Resistor 205A3 may be used to tune the matching network, provide variable attenuation, and/or provide bias to LNA 205A. Similarly, LC matching network 210B (see FIG. 4) is implemented in circuit arrangement 500 as inductor 205B 1 and capacitor 205B2. Resistor 205B3 may be used to tune the matching network, provide variable attenuation, and/or provide bias to LNA 205B.

Note that, similar to the PA in FIG. 3, PA 215 in FIG. 5 includes several PA slices or PA circuits 215A-215C. PA slices 215A-215C may include circuitry for individual PAs. Depending on factors such as desired transmit power (or range), frequency or band of operation, and the like, one or more of PA slices 215A-215C may be activated and used to drive a selected one of antennae 110-115.

Circuit arrangement 500 shows three PA slices 215A, 215B, and 215C. As persons of ordinary skill in the art will understand, however, other numbers of PA slices may be used, depending on factors such as desired power levels, design and performance specifications, available technology, etc.

Circuit arrangement 500 shows receive path circuitry 310, which includes receive circuits 145 and RSSI circuit 315. RSSI circuit 315 determines a signal strength of the RF signal received by receive circuits 145 via a selected one of antennae 110-115. RSSI circuit 315 provides an indication of the received signal strength to controller 135. Controller 135 may use the information or indication of the received signal strength as a criterion in selecting one of antennae 110-115 by using switches 120-125, as described above in detail.

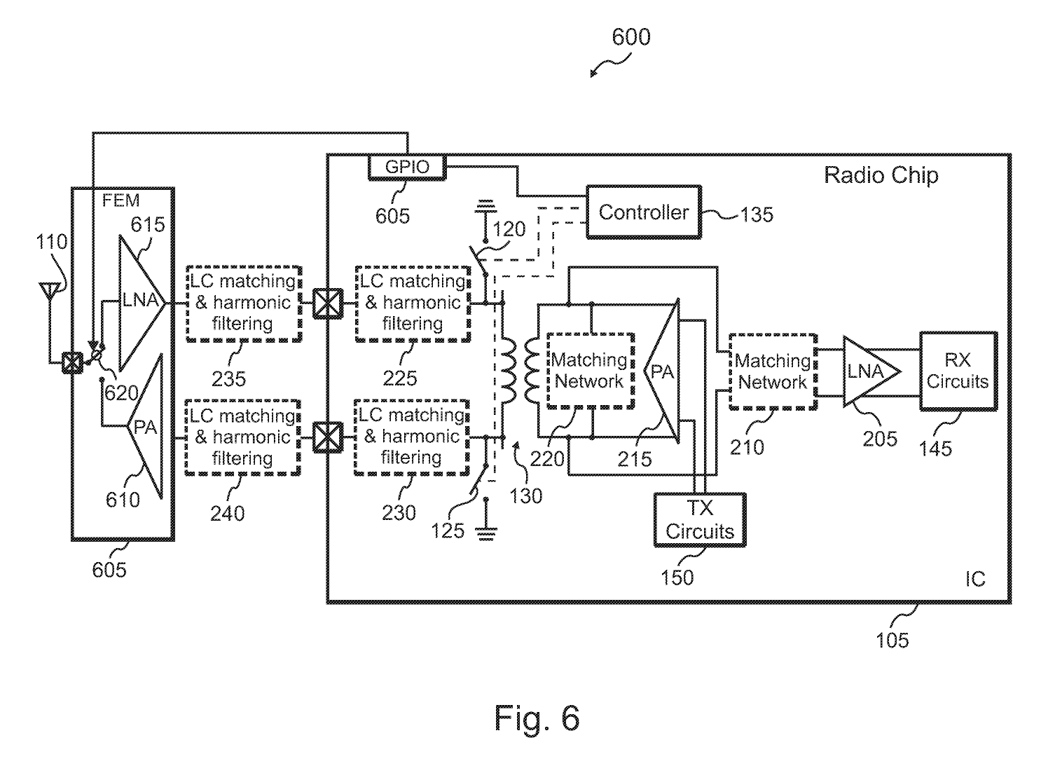

Another aspect of the disclosure relates to using integrated antenna control with RF apparatus that uses one antenna, rather than multiple antennae. FIG. 6 illustrates a circuit arrangement 600 according to an exemplary embodiment for antenna control in an apparatus with one antenna 110.

Circuit arrangement 600 includes antenna 110, which couples to IC 105 via FEM 605. In the embodiment shown, FEM 605 includes LNA 615 and PA 610. Using LNA 615 provides a gain block in closer proximity to antenna 110 (than, say, using an LNA in IC 105). As a result, the noise figure of circuit arrangement 600 during the receive mode of operation improves.

Furthermore, in the embodiment shown, FEM 605 includes PA 610. PA 610 may be used to provide higher transmit power in situations where the user of the apparatus desired more transmit power than PA 215 provides.

In some embodiments, LNA 615 and PA 610 are implemented in FEM 605 using III-VI semiconductor technologies. As persons of ordinary skill in the art will understand, however, other semiconductor technologies may be used, as desired. The choice of semiconductor technology depends on factors such as available technology, cost, desired performance specifications, and the like.

Referring to FIG. 6, FEM 605 is controlled by IC 105 to switch between transmit and receive. Depending on the mode of operation of the RF circuitry, the FEM couples the antenna to the receive circuits or to the transmit circuits.

More specifically, controller 135 sends a control signal to FEM 605 via GPIO port 625 (or other port or coupling mechanism between IC 105 and FEM 605, as desired). When RF signal transmission is desired, controller 135 causes switch 120 to close and switch 125 to open. As a result, RF signals from PA 215 are routed to FEM 605 via balun 130, matching network 230, and matching network 240.

The transmit signal from IC 105 (e.g., via matching network 240) to PA 610. Under control of controller 135, switch 620 in FEM 605 couples the output of PA 610 to antenna 110. Consequently, RF signals are transmitted via antenna 110.

Conversely, when RF signal reception is desired, under control of controller 135, switch 620 in FEM 605 couples antenna 110 to the input of LNA 615. Controller 135 further causes switch 120 to open and switch 125 to close. As a result, RF signals from LNA 615 are routed to LNA 205 and receive circuits 145 matching network 235, matching network 225, balun 130, and matching network 210. Consequently, RF signals are received via antenna 110 and processed by receive circuits 145.

Note that a variety of alternatives to circuit arrangement 600 are possible and contemplated. For example, in some embodiments, LNA 615 may be omitted, while PA 610 is used. As another example, in some embodiments, PA 610 may be omitted, while LNA 615 is used.

As yet another example, in some embodiments, both LNA 615 and PA 610 may be omitted. In this situation, FEM 605 includes switch 620, which serves as a receive/transmit switch for circuit arrangement 600. LNA 205 and PA 215 may be used in such an arrangement, as described above in detail.

Some of the exemplary embodiments described include matching networks and/or harmonic filters. A variety of types and configurations of matching networks and harmonic filters may be used, as persons of ordinary skill in the art will understand. For example, in some embodiments, capacitive (C) or inductive (L) matching networks and/or harmonic filters may be used. As another example, in some embodiments,—resistor-capacitor (RC) or resistor-inductor (RL) matching networks and/or harmonic filters may be used. As another example, in some embodiments, capacitor-inductor (LC) matching networks and/or harmonic filters may be used. As another example, in some embodiments, resistor-capacitor-inductor (RLC) matching networks and/or harmonic filters may be used.

Furthermore, in some embodiments, matching networks and/or harmonic filters may be coupled between two devices or blocks or components (e.g., in a cascade configuration). In some embodiments, rather than between two devices or blocks or components, matching networks and/or harmonic filters may be coupled to two nodes of the same device, block, or component. In some embodiments, matching networks and/or harmonic filters may be coupled in parallel with two or more devices or blocks or components. Other configurations are also possible and contemplated.

The choice of the matching network and harmonic filter type and topology, and the choice of circuit configuration and topology for the circuits and blocks in which matching networks and harmonic filters are included depends on a number of factors. Such factors include design and performance specifications (e.g., impedance levels of various devices, components, etc.; frequencies or frequency ranges of interest), available technology, IC die-area constraints, power consumption, and the like, as persons of ordinary skill in the art will understand.

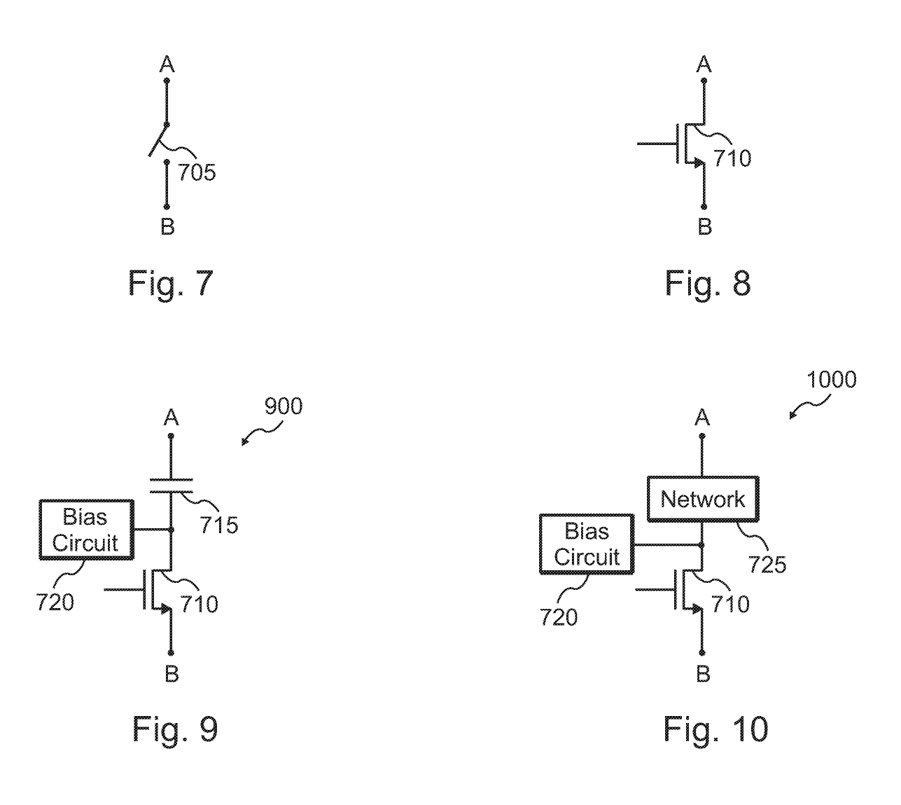

One aspect of the disclosure relates to circuitry or devices that may be used to implement switch 120 and/or switch 125. FIGS. 7-10 provide examples of such circuitry or devices according to exemplary embodiments.

FIG. 7 illustrates a switch 705 for use in apparatus according to exemplary embodiments. Switch 705 represents a generic switch (e.g., a switch approaching an ideal switch in its behavior and characteristics). When caused to close (e.g., by controller 135 (not shown)), switch 705 couples point A to point B with zero or negligible impedance, i.e., it approaches an ideal short-circuit between points A and B.

Switch 705 may be implemented using a variety of techniques and devices or circuits, as persons of ordinary skill in the art will understand. For example, in some embodiments, switch 705 may constitute a semiconductor device. As another example, in some embodiments, switch 705 may include more than one transistor, or transistors with different characteristics (e.g., p-type versus n-type, p-channel versus n-channel, etc.).

FIG. 8 shows a switch 710 for use in apparatus according to exemplary embodiments. Switch 710 constitutes an n-channel MOSFET. By applying an appropriate signal to the gate of switch 710, controller 135 (not shown) can cause switch 710 to turn on, and couple point A (drain) to point B (source).

Note that in other embodiments, switch 710 may constitute a p-channel MOSFET, as desired. In such embodiments, the control signal from controller 135 (not shown) is inverted (compared to when switch 710 constitutes an n-channel MOSFET) so as to properly control switch 710.

FIG. 9 depicts a circuit arrangement 900 to implement switch 120 and/or switch 125 in apparatus according to exemplary embodiments. In other words, circuit arrangement 900 may be substituted for switch 120 and/or switch 125 in the embodiments described.

Referring to FIG. 9, at RF frequencies, switch 120 or switch 125 generally function to provide an AC ground. Given that observation, capacitor 715 provides AC coupling between point A and transistor 710. Transistor 710 in turn provides coupling (in response a control signal from controller 135 (not shown) applied to its gate) between capacitor 715 and point B.

Bias circuit 720 provides appropriate DC bias for transistor 710. Bias circuit 720 may be implemented in variety of ways, as persons of ordinary skill in the art will understand. For example, in some embodiments, bias circuit 720 may simply include a resistor that couples the drain of transistor 710 to a voltage source (e.g., the supply voltage of IC 105).

FIG. 10 illustrates a circuit arrangement 1000 to implement switch 120 and/or switch 125 in apparatus according to exemplary embodiments. Put another way, circuit arrangement 1000 may be substituted for switch 120 and/or switch 125 in the embodiments described.

Circuit arrangement 1000 represents a more generalized version of circuit arrangement 900 (see FIG. 9). Referring to FIG. 10, circuit arrangement uses a general network 725 between point A and the drain of transistor 710. Network 725 generally provides an impedance that varies as a function of frequency. For example, network 725 may provide a reduced or minimum impedance at a single frequency, at multiple frequencies, in a range of frequencies, or in multiple ranges of frequencies in which the user of IC 105 seeks to receive or transmit RF signals.

In some embodiments, network 725 may include one or more inductors and one or more capacitors (i.e., an LC network). In some embodiments, network 725 may include one or more capacitors and one or more resistors (i.e., an RC network). In other embodiments, network 725 may include one or more inductors and one or more resistors (i.e., an RL network). In some embodiments, network 725 may include one or more resistors, one or more capacitors, and one or more inductors (i.e., an RLC network).

Given the AC coupling in FIG. 9 and possibly in FIG. 10 (depending on the topology of network 725), circuit arrangements 900 and 1000 may include protection circuitry to protect the relatively thin gate oxide of transistor 710 when in the off state. Such protection circuits may be implemented in a variety of ways and configurations, as persons of ordinary skill in the art will understand.

One aspect of the disclosure relates to ICs that can accommodate one or more RF technologies, standards, or protocols. For example, in exemplary embodiments, IC 105 or an apparatus that includes IC 105, may accommodate and operate in accordance with standards such as Wi-Fi, Bluetooth, ZigBee, cellular (2G, 2.5G, 3G, 4G, etc., including implementations such as GSM, etc.), and the like, as desired. Depending on whether RF signal reception, RF signal transmission, or both, are desired, receive circuits 145, transmit circuits 150, or both, respectively, may be used to accommodate desired RF technologies, standards, or protocols.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to those described here will be apparent to persons of ordinary skill in the art. Accordingly, this description teaches those skilled in the art the manner of carrying out the disclosed concepts, and is to be construed as illustrative only. Where applicable, the figures might or might not be drawn to scale, as persons of ordinary skill in the art will understand.

The forms and embodiments shown and described should be taken as illustrative embodiments. Persons skilled in the art may make various changes in the shape, size and arrangement of parts without departing from the scope of the disclosed concepts in this document. For example, persons skilled in the art may substitute equivalent elements for the elements illustrated and described here. Moreover, persons skilled in the art may use certain features of the disclosed concepts independently of the use of other features, without departing from the scope of the disclosed concepts.

1. An apparatus, comprising:
an integrated circuit (IC), comprising:
a radio-frequency (RF) circuit to process RF signals;
a balun having first and second ports, the first port of the balun coupled to the RF circuit; and
first and second switches coupled to the second port of the balun.

2. The apparatus according to claim 1, further comprising an antenna coupled to the second port of the balun via a front-end module (FEM).

3. The apparatus according to claim 2, wherein the FEM comprises a receive-transmit switch coupled to the antenna.

4. The apparatus according to claim 1, further comprising first and second antennae coupled to the second port of the balun.

5. The apparatus according to claim 4, wherein the RF circuit comprises receive circuitry.

6. The apparatus according to claim 4, wherein the RF circuit comprises transmit circuitry.

7. The apparatus according to claim 4, wherein the RF circuit comprises both receive circuitry and transmit circuitry.

8. The apparatus according to claim 4, further comprising a controller to control the first and second switches, wherein the controller opens the first switch and closes the second switch to select the first antenna; and wherein the controller closes the first switch and opens the second switch to select the second antenna.

9. The apparatus according to claim 4, further comprising a set of one or more matching networks coupled to the balun and to the RF circuit.

10. An apparatus, comprising:
a first antenna;
a second antenna;
an integrated circuit (IC), comprising:
a radio-frequency (RF) circuit to process RF signals;
a balun coupled to the RF circuit; and
first and second integrated switches coupled to the balun, the first and second integrated switches further coupled to the first and second antennae to allow selecting one of the first and second antennae.

11. The apparatus according to claim 10, wherein the first switch is opened and the second switch is closed in order to select the first antenna.

12. The apparatus according to claim 10, wherein the first switch is closed and the second switch is opened in order to select the second antenna.

13. The apparatus according to claim 10, wherein the balun comprises a transformer.

14. The apparatus according to claim 10, wherein the RF circuit comprises receive circuitry, transmit circuitry, or both.

15. A method of using first and second antennae in a radio-frequency (RF) apparatus including an integrated circuit (IC) having integrated therein (a) RF circuitry to process RF signals, (b) a balun having first and second nodes, and (c) first and second switches coupled to the first and second nodes of the balun, respectively, the method comprising:
controlling the first switch to couple to ground the first node of the balun in order for the RF circuitry to use the second antenna; and
controlling the second switch to couple to ground the second node of the balun in order for the RF circuitry to use the first antenna.

16. The method according to claim 15, wherein the balun comprises third and fourth nodes coupled to the RF circuitry.

17. The method according to claim 15, wherein the RF circuitry comprises receive circuitry.

18. The method according to claim 15, wherein the RF circuitry comprises transmit circuitry.

19. The method according to claim 15, wherein the RF circuitry comprises both receive circuitry and transmit circuitry.

20. The method according to claim 15, further comprising controlling the first and second switches according to one or more criteria.
